(19) United States
(12) Patent Application Publication
(10) Pub. No.: US 2026/0277876 A1
(43) Pub. Date: Sep. 17, 2026

(54) TRANSACTION LOG PROCESSING METHODS AND APPARATUSES

(71) Applicant: Beijing Oceanbase Technology Co., Ltd., Beijing (CN)

(72) Inventors: Wei TIAN, Hangzhou (CN); Hao LIU, Hangzhou (CN); Fusheng HAN, Hangzhou (CN)

(21) Appl. No.: 18/871,961

(22) PCT Filed: Aug. 16, 2023
(86) PCT No.: PCT/CN2023/113247

§ 371 Date: Dec. 5, 2024

(30) Foreign Application Priority Data
Sep. 6, 2022 (CN) 202211082758.5

(51) Int. Cl. G06F 16/23; G06F 11/1446

(52) U.S. Cl. CPC G06F 16/2379; G06F 11/1446

(57) ABSTRACT

Embodiments of this specification provide transaction log processing methods and apparatuses. All logs corresponding to one transaction are written into at least two log streams in a distributed database, and the method includes: obtaining at least two log streams from the distributed database, where each log stream carries a transaction identifier; determining, based on the transaction identifier carried in each log stream, whether all log streams into which all logs corresponding to one transaction are written have been obtained; and if yes, performing data assembly by using all the log streams to obtain transaction data corresponding to the transaction. According to this specification, a plurality of log streams for a distributed transaction can be assembled.

### TECHNICAL FIELD

One or more embodiments of this specification relate to the field of computer technologies, and in particular, to transaction log processing methods and apparatuses.

### BACKGROUND

The database records operations such as insertion, update, and deletion into logs. Therefore, based on the change data capture (CDC) technology of logs, a complete data change history of the database is obtained by parsing the logs, to implement data synchronization. For conventional stand-alone databases, such as Oracle and MySQL, there is only one log stream globally. Therefore, the transaction commit record history can be restored by obtaining the sequence and parsing the log stream, and the transaction commit sequence is equivalent to the sequence of transaction data records in the logs. For systems that support multi-point write, such as Oracle RAC, log streams are distributed on different machine nodes, but the system change number (SCN) is single-point allocated, and a monotonic increase is ensured. The transaction commit record history can be obtained by using the SCN sequence.

However, for distributed databases using multi-log streams, such as OceanBase, each log stream has its own independent log sequence number (LSN) and supports distributed transaction write. During distributed transaction write, different log streams may be distributed to a plurality of machine nodes. When a plurality of concurrent transactions exist, a log write sequence of different log streams is random, and the plurality of log streams have no global time sequence. Therefore, how to process transaction logs for a plurality of log streams of a distributed transaction to obtain transaction data of the transaction is an urgent problem to be solved.

### SUMMARY

One or more embodiments of this specification provide transaction log processing methods and apparatuses, to obtain transaction data of a distributed transaction by using a plurality of log streams of the transaction.

According to a first aspect, some embodiments of this specification provide a transaction log processing method, where a transaction is a database operation sequence for accessing and/or operating data, and all logs corresponding to one transaction are written into at least two log streams in a distributed database. The method includes: obtaining at least two log streams from the distributed database, where each log stream carries a transaction identifier; determining, based on the transaction identifier carried in each log stream, whether all log streams into which all logs corresponding to one transaction are written have been obtained; and if yes, performing data assembly by using all the log streams to obtain transaction data corresponding to the transaction.

According to an implementation in the embodiments of this specification, the method further includes: for each obtained log stream, performing the following operations: obtaining logs corresponding to a same transaction from the current log stream; and aggregating the obtained logs into a transaction shard corresponding to the transaction, where the transaction shard carries an identifier of the current log stream and a transaction identifier of the transaction. Accordingly, the determining whether all log streams into which all logs corresponding to one transaction are written have been obtained includes: determining, based on an identifier of a log stream and a transaction identifier that are obtained from each transaction shard, whether all log streams into which all logs corresponding to one transaction are written have been obtained. Accordingly, the performing data assembly by using all the log streams includes: assembling all transaction shards that carry a same transaction identifier.

According to an implementation in the embodiments of this specification, the method further includes: Each transaction identifier corresponds to a log stream list, and the log stream list includes identifiers of all log streams into which all logs corresponding to a transaction with the transaction identifier are written. Accordingly, the determining, based on an identifier of a log stream and a transaction identifier that are obtained from each transaction shard, whether all log streams into which all logs corresponding to one transaction are written have been obtained includes: for each transaction shard, performing the following operations: obtaining the identifier of the log stream and the transaction identifier from the current transaction shard, and marking, in a log stream list corresponding to the obtained transaction identifier, the obtained identifier of the log stream as arrival; and for each log stream list, if identifiers of all log streams in the current log stream list are marked as arrival, determining that all log streams into which all logs corresponding to one transaction are written have been obtained, where a transaction identifier of the transaction corresponds to the current log stream list.

According to an implementation in the embodiments of this specification, each time a transaction shard is aggregated, the method further includes: sending the aggregated transaction shard to one of more than one assembly queue. Before the determining, based on an identifier of a log stream and a transaction identifier that are obtained from each transaction shard, whether all log streams into which all logs corresponding to one transaction are written have been obtained, the method further includes: separately obtaining each transaction shard from the more than one assembly queue by using at least one thread.

According to an implementation in the embodiments of this specification, each log that is written into a log stream carries a prepare version. After the transaction data corresponding to the transaction is obtained, the method further includes: determining a sequence of transactions based on the prepare version carried in each log, and successively outputting transaction data of each transaction based on the sequence.

According to an implementation in the embodiments of this specification, the assembling all transaction shards that carry a same transaction identifier further includes: each time transaction data of a transaction is assembled, determining a commit version of the transaction data by using a prepare version carried in each log corresponding to the transaction, carrying the determined commit version in the transaction data, and then sending the transaction data to a sequence queue. The successively outputting transaction data of each transaction based on the sequence includes: outputting the transaction data of each transaction by using a commit version in each piece of transaction data and the sequence queue, where an output sequence is consistent with the sequence of the transactions.

According to an implementation in the embodiments of this specification, the method further includes: each time a transaction shard is aggregated, determining, based on a prepare version carried in each log used to aggregate the transaction shard, a version corresponding to the transaction shard; carrying the version in the transaction shard, and sending the transaction shard to one of the more than one assembly queue; and sending a global heartbeat value to each assembly queue at an interval of a predetermined time period, where the global heartbeat value is equal to the smallest value of versions carried in transaction shards sent to the assembly queues in the predetermined time period. Accordingly, the outputting the transaction data of each transaction by using a commit version in each piece of transaction data and the sequence queue includes: separately obtaining global heartbeat values from all the assembly queues; and if a same global heartbeat value is separately obtained from all the assembly queues, updating, by using the same global heartbeat value, a commit checkpoint corresponding to the sequence queue; and outputting transaction data in the sequence queue and whose commit version is less than or equal to the commit checkpoint.

According to an implementation in the embodiments of this specification, a version carried in a transaction shard is: one of prepare versions carried in logs used to aggregate the transaction shard; or a commit version of a transaction to which the transaction shard belongs, where the commit version is equal to the largest value of prepare versions carried in logs corresponding to the transaction.

According to a second aspect, some embodiments of this specification provide a transaction log processing apparatus, where a transaction is a database operation sequence for accessing and/or operating data, all logs corresponding to one transaction are written into at least two log streams in a distributed database, and the apparatus includes: a log stream acquisition unit, configured to obtain at least two log streams from the distributed database, where each log stream carries a transaction identifier; and a transaction assembly unit, configured to: determine, based on the transaction identifier carried in each log stream, whether all log streams into which all logs corresponding to one transaction are written have been obtained; and if yes, perform data assembly by using all the log streams to obtain transaction data corresponding to the transaction.

According to a third aspect, some embodiments of this specification provide a computer-readable storage medium. The computer-readable storage medium stores a computer program, and when the computer program is executed by a computer, the computer is enabled to perform the above-mentioned method.

According to a fourth aspect, some embodiments of this specification provide a computing device, including a memory and a processor. The memory stores executable code. When the processor executes the executable code, the above-mentioned method is implemented.

It can be learned from the foregoing technical solutions that a combination of one or more embodiments of this specification has at least the following advantages: (1) In the embodiments of this specification, after log streams are obtained from a distributed database, it is determined, based on a transaction identifier carried in each log stream, whether all log streams into which all logs corresponding to one transaction are written have been obtained. If yes, all the log streams are assembled, to obtain transaction data corresponding to the transaction. It can be learned that, according to the embodiments of this specification, transaction data of a distributed transaction can be obtained by using a plurality of log streams of the transaction.

(2) In the embodiments of this specification, the global heartbeat value and the commit checkpoint of the sequence queue are set based on the prepare version carried in each log, and the output sequence of the transaction data is controlled by using a relationship between the commit version of the transaction data in the sequence queue and the commit checkpoint of the sequence queue, to ensure correctness of the output sequence of the transaction data.

### BRIEF DESCRIPTION OF DRAWINGS

To describe the technical solutions in embodiments of this specification or in the existing technology more clearly, the following briefly describes the accompanying drawings needed for describing the embodiments or the existing technology. Apparently, the accompanying drawings in the following description show some embodiments of this specification, and a person of ordinary skill in the art can still derive other drawings from these accompanying drawings without creative efforts.

FIG. 1 is an example diagram illustrating an architecture of a system to which an embodiment of this specification is applied;

FIG. 2 is a flowchart illustrating a transaction log processing method, according to an embodiment of this specification;

FIG. 3 is a schematic diagram illustrating generation of a transaction shard. according to an embodiment of this specification;

FIG. 4 is a flowchart illustrating assembly processing, according to an embodiment of this specification;

FIG. 5 is an example diagram illustrating transaction data assembly, according to an embodiment of this specification;

FIG. 6 is a diagram illustrating a sequence instance of transaction data, according to an embodiment of this specification;

FIG. 7 is a schematic diagram illustrating generation of a global heartbeat value, according to an embodiment of this specification; and

FIG. 8 is a diagram illustrating a structure of a transaction log processing apparatus, according to an embodiment of this specification.

### DESCRIPTION OF EMBODIMENTS

The solutions provided in this specification are described below with reference to the accompanying drawings.

The terms used in the embodiments of this specification are merely for describing specific embodiments, and are not intended to limit this specification. The terms “a”, “said”, and “the” of singular forms used in the embodiments of this specification and the appended claims are also intended to include plural forms, unless otherwise specified in the context clearly.

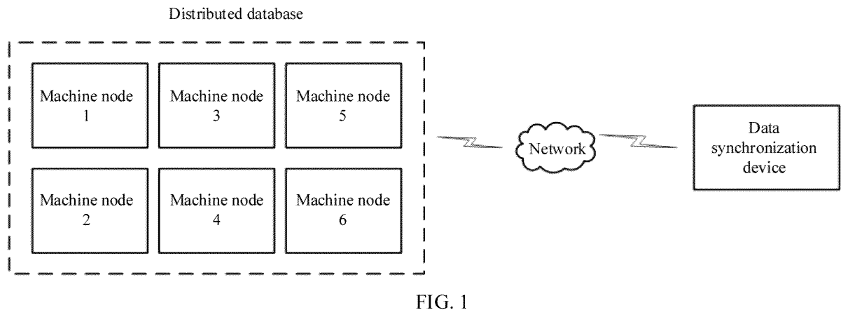

FIG. 1 illustrates an example of an architecture of a system to which an embodiment of this specification is applied. The system mainly includes a distributed database and a data synchronization device.

To ensure atomicity and persistence of data operations in a database system, a write-ahead logging (WAL) mechanism is usually used, that is, a log of a transaction is first persisted into a log stream. Distributed transactions support multi-machine write, where corresponding logs can be separately persisted to corresponding log streams, and a same log stream can be synchronized on different machine nodes. The log stream (LogStream) is a basic unit of log reading and writing, and records logs of transactions in the database.

The transaction is a database operation sequence for accessing and/or operating data. In computer terminology, the transaction is a program execution unit that accesses and may update data items in the database, consisting of all operations performed between a start of the transaction and an end of the transaction. All operations need to be completed successfully. Otherwise, all changes made in each operation may be canceled. For example, a transfer transaction may include increasing the balance of one account and reducing the balance of another account.

In the distributed database, all logs corresponding to one transaction are usually written into at least two log streams.

The data synchronization device may pull a log stream from the distributed database, and perform processing according to the transaction log processing method provided in the embodiments of this specification, to obtain the transaction data of each transaction through assembling. Further, data synchronization is performed based on a dependency relationship or sequence of transaction data.

The distributed database may use a plurality of machine nodes as instances of running software of the distributed database. The data synchronization device may interact with the distributed database through a network, and the network can include various connection types such as wired and wireless communication links, or fiber optic cables.

The data synchronization device may be a single server, a server group formed by a plurality of servers, or a cloud server. The cloud server is also referred to as a cloud computing server or a cloud host, and is a host product in a cloud computing service system, to resolve a defect that management difficulty in a conventional physical host and a virtual private server (VPs) service is great, and service extensibility is weak. In addition, the cloud server may alternatively be a computer terminal that has a relatively strong computing capability.

It should be understood that quantities of distributed databases, machine nodes, and data synchronization devices in FIG. 1 are merely an example. Based on implementation needs, any quantity of distributed databases, machine nodes, or data synchronization devices may be available.

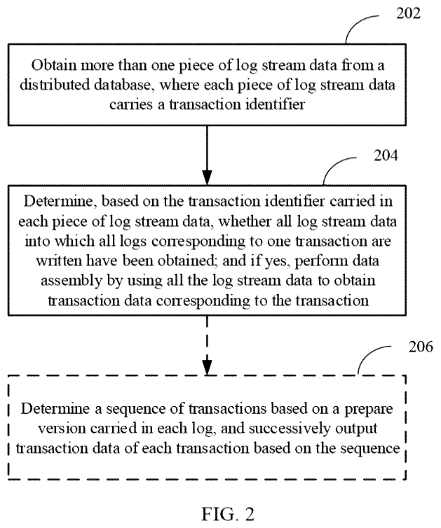

FIG. 2 is a flowchart illustrating a transaction log processing method, according to an embodiment of this specification. It may be understood that the method may be performed by the data synchronization device in the system shown in FIG. 1. As shown in FIG. 2, the method includes the following steps: Step 202: Obtain more than one log stream from the distributed database, where each log stream carries a transaction identifier.

Step 204: Determine, based on the transaction identifier carried in each log stream, whether all log streams into which all logs corresponding to one transaction are written have been obtained; and if yes, perform data assembly by using all the log streams to obtain transaction data corresponding to the transaction.

It can be learned from the technical content provided in the above-mentioned embodiments that after log streams are obtained from the distributed database, it is determined, based on a transaction identifier carried in each log stream, whether all log streams into which all logs corresponding to one transaction are written have been obtained. If yes, all the log streams are assembled, to obtain transaction data corresponding to the transaction. It can be learned that, according to the embodiments of this specification, a plurality of log streams of a distributed transaction are assembled, to obtain transaction data of the transaction.

The following describes the steps shown in FIG. 2.

Step 202 of “obtaining more than one log stream from the distributed database” is first described in detail with reference to embodiments.

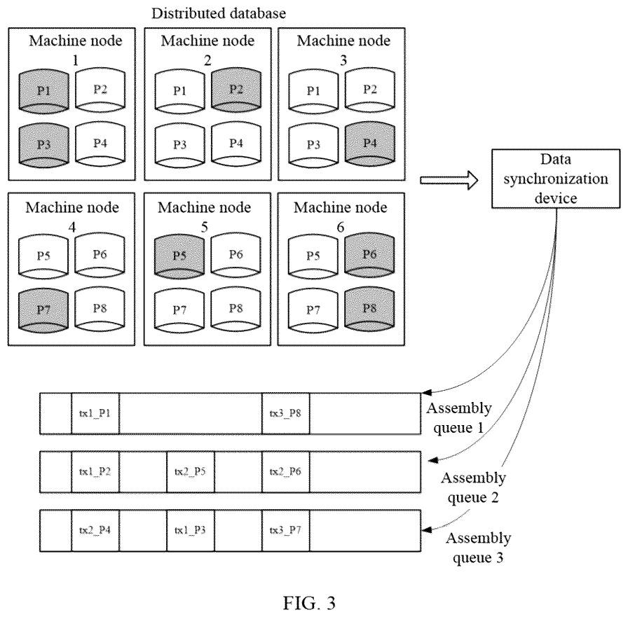

In distributed databases such as OceanBase, there are usually a plurality of log streams. FIG. 3 is used as an example. There are eight log streams, namely, PI to P8, and each log stream may have a plurality of copies. In FIG. 3, a part with gray scale indicates a primary copy, a part without gray scale indicates a secondary copy, and each copy is distributed on a different machine node. In the distributed database, each machine node may ensure data consistency of each copy of the log stream by using, for example, a Paxos algorithm.

In the embodiments of this specification, the data synchronization device may pre-obtain a log distribution table in the distributed database, where the log distribution table records a distribution status of each log stream. The data synchronization device may obtain each log stream from the database based on the log distribution table, for example, log streams P1 to P8 in FIG. 3.

To accelerate efficiency of obtaining log streams, a plurality of log streams may be obtained concurrently from the distributed database by using a remote procedure call (RPC). For example, eight processes are separately used to obtain log streams P1 to P8. Based on the log distribution table, each process obtains each log stream from the corresponding machine node. The log stream may be first obtained from the primary copy by default. If the primary copy is unavailable, the log stream is obtained from the secondary copy. The log stream may alternatively be obtained from either of the primary copy and the secondary copy based on a predetermines load balancing policy.

The following describes in detail step 204 of “determining, based on the transaction identifier carried in each log stream, whether all log streams into which all logs corresponding to one transaction are written have been obtained; and if yes, performing data assembly by using all the log streams to obtain transaction data corresponding to the transaction” with reference to embodiments.

One transaction usually corresponds to a plurality of logs, which are usually written into a plurality of log streams. For example, transaction 1 corresponds to five logs, and the five logs are separately written into log stream 1, log stream 2, and log stream 3. Therefore, one log stream may include one or more logs of a same transaction. Based on this, in some embodiments of this specification, a concept of transaction shards is proposed. The transaction shard is aggregation of all logs, in a same log stream, that correspond to a same transaction. Each transaction shard has a transaction identifier and a log stream identifier, that is, carries a transaction identifier of a transaction to which a log of the transaction shard belongs and an identifier of a log stream of the transaction shard. Therefore, between step 202 and step 204, step 203 may be further included: Obtain all logs corresponding to a same transaction from each log stream, and aggregate all logs corresponding to a same transaction from a same log stream into a processing unit corresponding to the transaction, where the processing unit is referred to as a transaction shard. Accordingly, in subsequent step 204, a plurality of transaction shards corresponding to a same transaction and obtained from a plurality of log streams may be assembled, that is, all transaction shards that carry the same transaction identifier are assembled to assemble transaction data of the same transaction.

The processing in step 203 is described by using examples. For example, log 1 and log 2 of transaction 1 are written into log stream 1, and log 1 and log 2 of transaction 1 are obtained from log stream 1. Log 1 and log 2 are aggregated together to form a transaction shard of transaction 1, which is denoted as transaction shard 1. The transaction shard 1 carries the identifier of transaction 1 and the identifier of log stream 1. Log 3 of transaction 1 is written into log stream 2, and log 3 of transaction 1 is obtained from log stream 2. Log 3 is used as another transaction shard of transaction 1, and is denoted as transaction shard 2. Transaction shard 2 carries the identifier of transaction 1 and the identifier of log stream 2. Log 4 and log 5 of transaction 1 are written into log stream 3, and log 4 and log 5 of transaction 1 are obtained from log stream 3. Log 4 and log 5 are aggregated together to for another transaction shard of transaction 1, which is denoted as transaction shard 3. Transaction shard 3 carries the identifier of transaction I and the identifier of log stream 3. Subsequently, the three transaction shards are assembled to obtain transaction data of transaction 1.

The process of aggregating all logs, in a same log stream, that correspond to a same transaction may include: Sorting all the logs in sequence, or combining all the logs in sequence. For example, a log stream includes log S1 of reducing account a by A yuan and log S2 of adding account a by B yuan. Then, the transaction shard aggregated by using log S1 and log S2 may include two operations: reducing account a by A yuan and adding account a by B yuan.

For log streams in the distributed database, to distinguish between the log streams, each log stream carries a transaction identifier and a log stream identifier. The log stream identifier may be, for example, a log sequence number (LSN) of the log stream. Generally, log data of a transaction may be divided into a plurality of log streams and written into different machine nodes. Therefore, to distinguish and identify a transaction to which each log stream belongs, a transaction identifier is carried in the log stream. In addition, a plurality of log streams in a transaction are separately distinguished by using different log stream identifiers.

For example, it is assumed that three distributed transactions occur in the distributed database, which are denoted as tx1, tx2, and tx3. The log data of the transaction tx1 is written into log streams P1 to P3. These log streams carry the transaction identifier tx1 and carry the respective log stream identifiers P1 to P3. The log data of the transaction tx2 is written into log streams P4 to P6. These log streams carry the transaction identifier tx2 and carry the log stream identifiers P4 to P6. The log data of the transaction tx3 is written into log streams P7 to P8. These log streams carry the transaction identifier tx3 and carry the respective log stream identifiers P7 to P8.

After each transaction shard is obtained in step 203, in step 204, when it is determined whether all log streams into which all logs corresponding to one transaction are written have been obtained, step 2041 is specifically performed: Determine, based on an identifier of a log stream and a transaction identifier that are obtained from each transaction shard, whether all log streams into which all logs corresponding to one transaction are written have been obtained.

During actual service implementation, step 202 is usually performed by using a plurality of threads. To be specific, the plurality of threads separately obtain the at least two log streams from the distributed database. In this way, obtaining time of the plurality of log streams has a sequence. In other words, some log streams arrive first (that is, are obtained first), and some log streams arrive later (that is, are obtained later). As such, a log stream list may be used to implement the process of step 2041. In the distributed database, to distinguish between log streams of a same transaction, a log stream list corresponding to each transaction identifier is recorded, and the log stream list includes identifiers of all log streams into which all logs corresponding to a transaction with the transaction identifier are written.

In an implementation, the data synchronization device may obtain, in advance from the distributed database, the log stream list corresponding to each transaction identifier. For example, if all logs of transaction tx1 are written into three log streams, the log stream list corresponding to transaction identifier tx1 includes identifiers of the three log streams, namely, P1, P2, and P3.

In another implementation, the distributed database may carry, in each log stream, the log stream list corresponding to the transaction identifier of the transaction to which the log stream belongs. For example, all logs of transaction tx1 are written into three log streams, including P1, P2, and P3. In this case, the log streams of P1, P2, and P3 each include the log stream list corresponding to tx1. The log stream list includes P1, P2, and P3, and is used to indicate which log streams correspond to tx1. After the obtained logs are aggregated into a transaction shard corresponding to the transaction, each transaction shard also carries the log stream list of the log streams of the transaction shard.

As such, the process of step 2041 may include the following steps: Step 2041A: For each transaction shard, perform the following operations: obtaining the identifier of the log stream and the transaction identifier from the current transaction shard, and marking, in a log stream list corresponding to the obtained transaction identifier, the obtained identifier of the log stream as arrival. Step 2041B: For each log stream list, if identifiers of all log streams in the current log stream list are marked as arrival, determine that all log streams into which all logs corresponding to one transaction are written have been obtained, where a transaction identifier of the transaction corresponds to the current log stream list.

For example, for step 2041A, for transaction shard 1, the identifier of log stream PI and transaction identifier tx1 are obtained from transaction shard 1. In this case, PI is marked as arrival in the log stream list (where the list includes P1, P2, and P3) corresponding to tx1. As such, after the processing in 2041A is performed for each transaction shard, if P1, P2, and P3 in a log stream list like the log stream list corresponding to tx1 are marked as arrival, it indicates that all the log streams into which all the logs of transaction tx1 are written have been obtained. In other words, all transaction shards of transaction tx1 have been obtained from all the log streams, that is, all the logs of transaction tx1 have been obtained, and the transaction data of transaction tx1 may be assembled.

In some embodiments of this specification, each time a transaction shard is aggregated, the method further includes: sending the aggregated transaction shard to one of more than one assembly queue. Before the determining, based on an identifier of a log stream and a transaction identifier that are obtained from each transaction shard, whether all log streams into which all logs corresponding to one transaction are written have been obtained, the method further includes: separately obtaining each transaction shard from the more than one assembly queue by using at least one thread.

In an implementation, there may be one assembly quene in the data synchronization device. Transaction shards obtained in the above-mentioned step are sent to the assembly queue for subsequent assembly, but performance in this method is relatively low.

To optimize assembly performance and support concurrent processing, this embodiment of the specification provides another implementation, that is, a plurality of assembly queues are used. Transaction shards obtained in the above-mentioned step are stored in the plurality of assembly quenes. As shown in FIG. 3, it is assumed that three assembly quenes exist. For the transaction shards obtained in the above-mentioned step, each transaction shard generated from each log may be sent to the plurality of assembly queues in a round-robin (round-robin) way. For example, transaction shards tx1_Pl (indicating that the transaction identifier of the transaction shard and the identifier of the log stream are respectively tx1 and P1, where similar expression is subsequently used), tx1_P2, and tx1_P3 are respectively located in assembly queues 1 to 3; tx2_P4, tx2_P5, and tx2_P6 are respectively located in queue 3, queue 2, and queue 2; and tx3_P7 and tx3_PS are respectively located in queue 3 and queue 1.

The assembly queue is a first-in first-out queue. Each assembly queue may be bound to an assembly thread to perform subsequent assembly of transaction shards.

In step 204, a difficulty for the transaction shards is how to learn which transaction shards belong to a same transaction and whether transaction shards belonging to a same transaction have been obtained and assembly can be started. To resolve this difficulty, in this embodiment of this specification, the log stream list and the identifier of the log stream are used to assemble transaction shards of a same transaction.

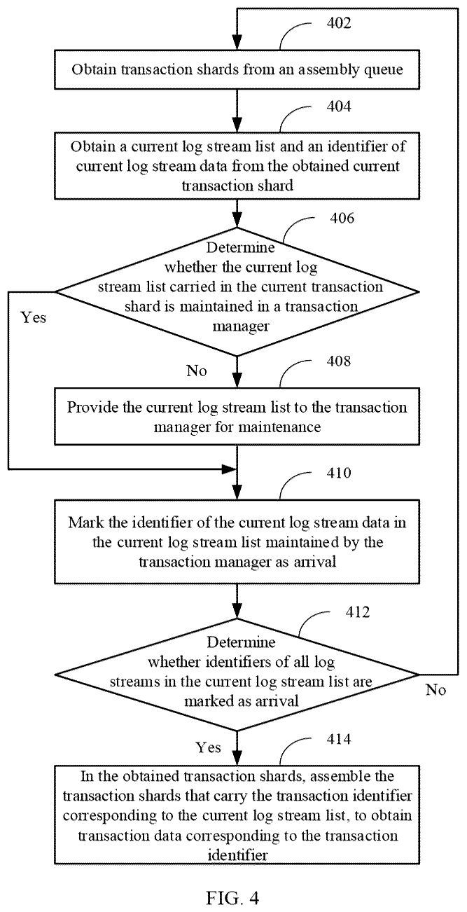

In an implementation, for each assembly thread, an assembly processing procedure shown in FIG. 4 may be performed. As shown in FIG. 4, the assembly processing procedure may include the following steps: Step 402: Obtain a transaction shard from an assembly queue.

Step 404: Obtain the log stream list and the identifier of the log stream from the obtained current transaction shard. For ease of description, the log stream list and the identifier of the log stream that are obtained from the current transaction shard are referred to as the current log stream list and the identifier of the current log stream.

Step 406: Determine whether the current log stream list carried in the current transaction shard is maintained in the transaction manager; and if not, perform step 408; if yes, perform step 410.

To improve processing efficiency, in this embodiment of this specification, transaction shards in the assembly queues are concurrently processed in a multi-thread way. To learn whether the transaction shards obtained by each thread can be assembled, that is, all transaction shards corresponding to one transaction have been obtained, in this embodiment of this specification, the transaction manager is disposed. The transaction manager uniformly maintains obtained transaction shard information. In other words, the “context” of each transaction shard obtained from the assembly queue is recorded in the transaction manager and can be queried from the transaction manager. Certainly, the log stream list corresponding to each transaction identifier may be uniformly maintained in another way. In this embodiment, only the transaction manager is used as an example for description.

Step 408: Provide the current log stream list to the transaction manager for maintenance.

The log stream list of each transaction is maintained in the transaction manager. The log stream list of each transaction corresponds to the transaction identifier, and includes identifiers of all log streams corresponding to the transaction identifier.

Step 410: Mark the identifier of the current log stream in the current log stream list maintained by the transaction manager as arrival.

Step 412: Determine whether identifiers of all log streams in the current log stream list are marked as arrival, and if yes, perform step 414; otherwise, perform step 402.

Step 414: In the obtained transaction shards, assemble the transaction shards that carry the transaction identifier corresponding to the current log stream list, to obtain transaction data corresponding to the transaction identifier.

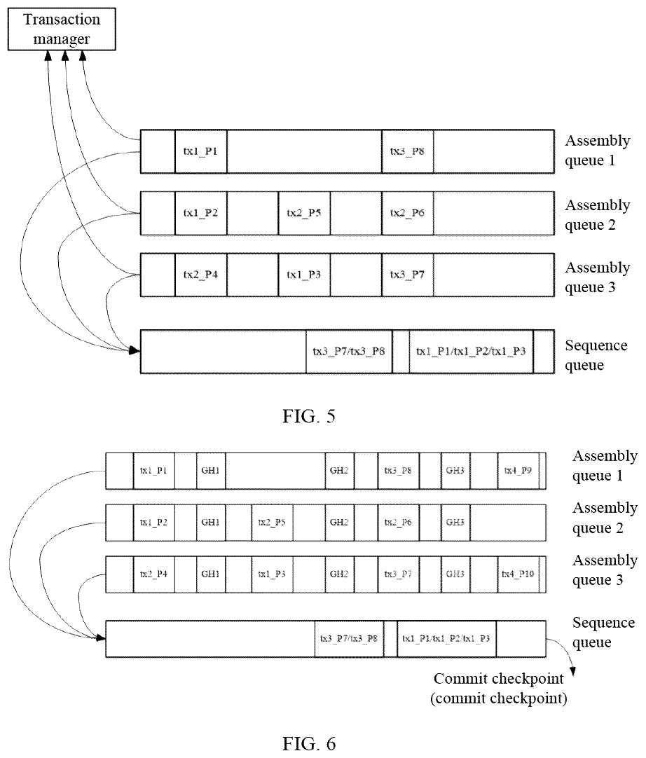

To facilitate understanding of the above-mentioned procedure, FIG. 5 is used as an example for description in the following. First, transaction shard tx1 P1 is obtained from assembly queue 1, and the log stream list of tx1 and identifier PI of the log stream are obtained from the transaction shard. Because the transaction manager does not store the log stream list of tx1, the log stream list of tx1 is provided to the transaction manager for storage, and identifier P1 of the log stream is marked as arrival in the log stream list of tx1 maintained by the transaction manager. After tx2_P2 is obtained from assembly queue 2, the log stream list of tx1 and identifier P2 of the log stream are obtained from the transaction shard. Because the transaction manager already stores the log stream list of tx1, identifier P2 of the log stream is marked as arrival in the log stream list of tx1 maintained by the transaction manager. Transaction shard tx2_P4 is obtained from assembly queue 3, and the log stream list of tx2 and identifier P4 of the log stream are obtained from the transaction shard. Because the transaction manager does not store the log stream list of tx2, the log stream list of tx2 is provided to the transaction manager for storage, and identifier P4 of the log stream is marked as arrival in the log stream list of tx2 maintained by the transaction manager. After tx2_P5 is obtained from assembly queue 2, the log stream list of tx2 and identifier P5 of the log stream are obtained from the transaction shard. Because the transaction manager already stores the log stream list of tx2, identifier P5 of the log stream is marked as arrival in the log stream list of tx2 maintained by the transaction manager. After tx1_P3 is obtained from assembly queue 3, the log stream list of tx1 and identifier P3 of the log stream are obtained from the transaction shard. Because the transaction manager already stores the log stream list of tx1, identifier P3 of the log stream is marked as arrival in the log stream list of tx1 maintained by the transaction manager. In this case, the identifiers of all the log streams in the log stream list of tx1 are marked as arrival. Therefore, received transaction shards that carry tx1 may be assembled to obtain the transaction data corresponding to tx1. Processing of another transaction shard is similar. As such, transaction shards corresponding to each transaction identifier can be separately assembled.

However, because the assembly of distributed transaction data is performed concurrently, the sequence of transaction data shown in FIG. 5 may be obtained. To be specific, the transaction data of tx1 may be sent to the sequence queue first, then the transaction data of tx3 is input to the sequence queue, and then the transaction data of tx2 fails to be sent to the sequence queue due to concurrent execution or other reasons. If the transaction data of tx2 fails to be sent to the sequence queue for a long time, it may cause a case that after the transaction data of tx1 is output, the transaction data of tx3 is first output. Correctness and integrity of the output sequence cannot be ensured. However, in some cases, the transaction data between the transactions is dependent. For example, if transaction tx2 depends on tx1 and tx3 depends on tx2, it needs to be ensured that tx1 is first output, tx2 is then output, and tx3 is finally output. Therefore, the assembled transaction data needs to be further sequenced, that is, the sequence of the transaction data needs to be determined to determine correctness of the transaction data.

In some embodiments of this specification, each log that is written into a log stream carries a prepare version. After the transaction data corresponding to each transaction is obtained, as shown in FIG. 2, sequence processing is further performed on the transaction data. The sequence processing may include step 206: Deternine a sequence of transactions based on the prepare version carried in each log, and successively output transaction data of each transaction based on the sequence.

In some embodiments of this specification, the assembling all transaction shards that carry a same transaction identifier further includes: each time transaction data of a transaction is assembled, determining a commit version of the transaction data by using a prepare version carried in each log corresponding to the transaction, carrying the determined commit version in the transaction data, and then sending the transaction data to a sequence queue. As such, the successively outputting transaction data of each transaction based on the sequence in step 206 includes step 2061: Output the transaction data of each transaction by using a commit version in each piece of transaction data and the sequence queue, where an output sequence is consistent with the sequence of the transactions.

In some embodiments of this specification, the method further includes: each time a transaction shard is aggregated, determining, based on a prepare version carried in each log used to aggregate the transaction shard, a version corresponding to the transaction shard; carrying the version in the transaction shard, and sending the transaction shard to one of the more than one assembly queue; and sending a global heartbeat value to each assembly queue at an interval of a predetermined time period, where the global heartbeat value is equal to the smallest value of versions carried in transaction shards sent to the assembly queues in the predetermined time period. Accordingly, step 2061 includes: Separately obtain global heartbeat values from all the assembly queues; and if a same global heartbeat value is separately obtained from all the assembly queues, update, by using the same global heartbeat value, a commit checkpoint corresponding to the sequence queue; and output transaction data in the sequence queue and whose commit version is less than or equal to the commit checkpoint.

The following describes in detail the sequence processing in step 206.

The sequence queues may be implemented by using a small top-heap. Transaction data in the sequence queues are arranged in descending order based on commit versions.

In the embodiments of this specification, a new parameter, namely, a global heartbeat value, may be introduced to sequence the transaction data. To facilitate understanding of the subsequent sequencing process, several related concepts are first described as follows: Prepare version: In distributed databases such as OceanBase, atomicity of distributed transactions are ensured by using the two-phase commit (2PC) protocol. Each participant of the transactions generates a prepare version in the negotiation process, and therefore, each log has information about the prepare version. Accordingly, in the embodiments of this specification, the transaction shard generated by aggregating the logs in the log streams may also have a version, and the version corresponding to the transaction shard is determined based on the prepare version carried in each log used to aggregate the transaction shard. The prepare version is usually incremented based on the sequence of transaction occurrence.

In an implementation, the version corresponding to the transaction shard may be one of prepare versions carried in logs used to aggregate the transaction shard.

In another implementation, the version corresponding to the transaction shard may be a commit version of a transaction to which the transaction shard belongs.

Commit version: In the distributed transaction scenario, each participant can obtain a commit version of a transaction through negotiation. The commit version usually uses the largest value of prepare versions that logs of a transaction have. Accordingly, in the embodiments of this specification, after transaction shards of a same transaction are assembled, information about a commit version of transaction data may be obtained.

A global heartbeat (GH) value is a global value sent to each assembly queue at each predetermined time period, and is generated based on the version corresponding to the transaction shard carried in the obtained transaction shard. In an implementation, the Globalheartbeat value is determined by the smallest value of the versions carried in the transaction shards sent to each assembly queue within the predetermined time period.

A specific generation and application method of the global heartbeat value is described in detail in subsequent embodiments.

The commit checkpoint is a parameter maintained for a sequence queue, and is used to determine whether transaction data in the sequence queue can be output. The commit checkpoint is determined based on Globalheartbeat. If all assembly threads obtain Globalheartbeat, the value of the commit checkpoint is updated to the Globalheartbeat value. For the sequence queue, all transaction data whose commit versions are less than or equal to the conunit checkpoint may be output.

The following first describes the Globalheartbeat sending mechanismn.

In an implementation, Globalheartbeat can be periodically determined and sent to the assembly queues.

In another implementation, Globalheartbeat can be determined and sent to the assembly queues each time sending of the transaction shards is polled for the assembly queues. Other sending occasions may alternatively be used, which are not listed here one by one.

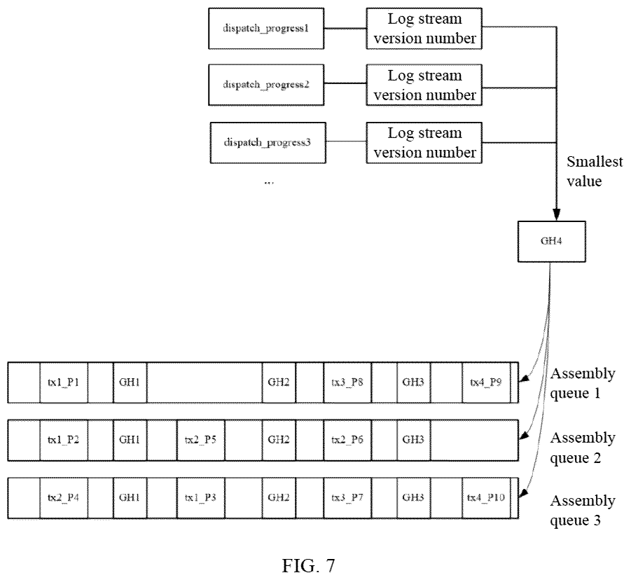

As mentioned in the above-mentioned embodiments, the log streams may be obtained in the multi-process manner and the transaction shard of the transaction is obtained by aggregating the log streams. As shown in FIG. 7, each process (dispatch progress) corresponds to a log stream version.

In an implementation, after obtaining the transaction shard, each dispatch progress updates the log stream version of the dispatch progress based on the version of the transaction shard. If the version of the currently obtained transaction shard is less than the log stream version, the log stream version is updated by using the version of the transaction shard. Otherwise, the log stream version is not updated.

When an occasion of determining and sending Globalheartbeat is reached, for example, a sending period is reached, the smallest value of the log stream version of each current dispatch progress is used as Globalheartbeat, and is sent to each assembly queue.

As shown in FIG. 6, GH1 is the smallest value of the versions in tx1_P1, tx1_P2, and tx2_P4, namely, the version of tx1_P1. GH2 is the smaller value of the versions in tx2_P5 and tx1_P3, namely, the version of tx1_P3. GH3 is the smallest value of the versions in tx3_P8, tx2_P6, and tx3_P7, namely, the version of tx2_P6.

When each assembly thread obtains GHI, the commit checkpoint is set to the value of GH1. In this case, the transaction data of tx1 and tx2 is not assembled yet, and there is no data in the sequence queue.

When each assembly thread obtains GH2, the commit checkpoint is set to the value of GH2, namely, the version of tx1_P3. In this case, the transaction data of tx1 is assembled and located in the sequence queue, and the commit version of the transaction data of tx1 is the largest value of all prepare versions in tx1_P1, tx1_P2, and tx1_P3. This means that the current commit checkpoint is less than the comunit version of tx1, and the sequence queue does not output.

When each assembly thread obtains GH3, the commit checkpoint is set to the value of GH3, namely, the version of tx2_P6. In this case, the transaction data of tx2 and tx3 is assembled and located in the sequence queue. The commit version of the transaction data of tx2 is the largest value of all prepare versions in tx2_P4, tx2_P5, and tx2_P6. The commit version of the transaction data of tx3 is the larger value of both prepare versions in tx3_P7 and tx3_8. This means that the current commit checkpoint is greater than the commit version of tx1 and is equal to the commit version of tx2. Therefore, the transaction data of tx1 and tx2 is sequentially output, and the transaction data of tx3 is not output. It can be learned that the correct output sequence of the transaction data is ensured.

Subsequent processes can be deduced by analogy. It can be learned that the commit checkpoint is combined with GH to form a function similar to “barrier”, allowing only transaction data with the correct sequence to be output. On the one hand, it is ensured that the transaction data is completely received and output in the correct sequence, and on the other hand, it is ensured that the output sequence of the transaction data is consistent with the commit sequence.

The method provided in the embodiments of this specification is described in detail above, and the following describes in detail an apparatus provided in the embodiments of this specification.

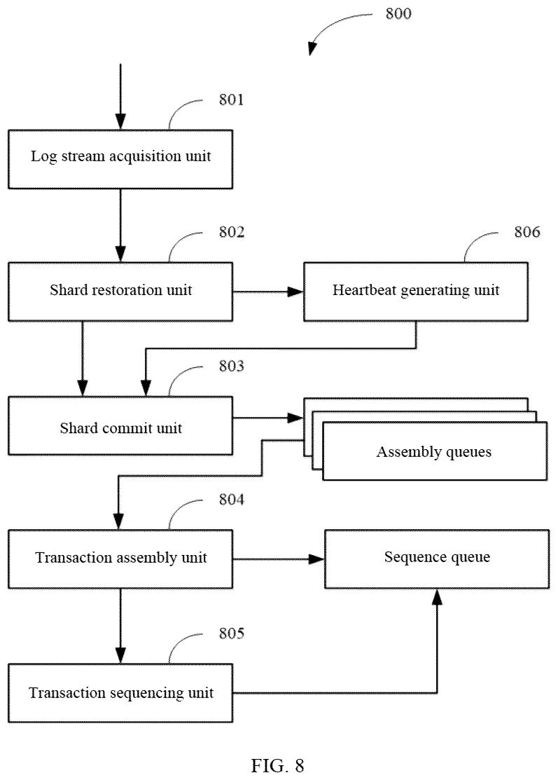

FIG. 8 is a diagram illustrating a structure of a transaction log processing apparatus, according to an embodiment of this specification. As shown in FIG. 8, the apparatus 800 may include a log stream acquisition unit 801 and a transaction assembly unit 804, and may further include a shard acquisition unit 802, a shard commit unit 803, a transaction sequencing unit 805, and a heartbeat generating unit 806. Main functions of each composition unit are as follows: The log stream acquisition unit 801 is configured to obtain at least two log streams from a distributed database, where each log stream carries a transaction identifier.

The transaction assembly unit 804 is configured to: determine, based on the transaction identifier carried in each log stream, whether all log streams into which all logs corresponding to one transaction are written have been obtained; and if yes, perform data assembly by using all the log streams to obtain transaction data corresponding to the transaction.

In an implementation, the shard acquisition unit 802 is configured to: for each obtained log stream, perform the following operations: obtaining logs corresponding to a same transaction from the current log stream; and aggregating the obtained logs into a transaction shard corresponding to the transaction, where the transaction shard carries an identifier of the current log stream and a transaction identifier of the transaction.

Accordingly, when determining whether all log streams into which all logs corresponding to one transaction are written have been obtained, the transaction assembly unit 804 is configured to: determine, based on an identifier of a log stream and a transaction identifier that are obtained from each transaction shard, whether all log streams into which all logs corresponding to one transaction are written have been obtained.

Accordingly, when performing data assembly by using all the log streams, the transaction assembly unit 804 may be configured to assemble all transaction shards that carry a same transaction identifier.

In an implementation, each transaction identifier corresponds to a log stream list, and the log stream list includes identifiers of all log streams into which all logs corresponding to a transaction with the transaction identifier are written.

When determining, based on an identifier of a log stream and a transaction identifier that are obtained from each transaction shard, whether all log streams into which all logs corresponding to one transaction are written have been obtained, the transaction assembly unit 804 may be configured to: for each transaction shard, perform the following operations: obtaining the identifier of the log stream and the transaction identifier from the current transaction shard, and marking, in a log stream list corresponding to the obtained transaction identifier, the obtained identifier of the log stream as arrival; and for each log stream list, if identifiers of all log streams in the current log stream list are marked as arrival, determining that all log streams into which all logs corresponding to one transaction are written have been obtained, where a transaction identifier of the transaction corresponds to the current log stream list.

In an implementation, the shard commit unit 803 is configured to: each time the shard acquisition unit 802 aggregates a transaction shard, send the aggregated transaction shard to one of more than one assembly queue.

The transaction assembly unit 804 is configured to separately obtain each transaction shard from the more than one assembly queue by using at least one thread.

In an implementation, each log that is written into a log stream carries a prepare version.

The transaction sequencing unit 805 is configured to: determine a sequence of transactions based on the prepare version carried in each log, and successively output transaction data of each transaction based on the sequence.

In an implementation, the transaction assembly unit 804 is configured to: each time transaction data of a transaction is assembled, determine a commit version of the transaction data by using a prepare version carried in each log corresponding to the transaction, carry the determined commit version in the transaction data, and then send the transaction data to a sequence queue.

Accordingly, the transaction sequencing unit 805 is configured to output the transaction data of each transaction by using a commit version in each piece of transaction data and the sequence queue, where an output sequence is consistent with the sequence of the transactions.

In an implementation, the shard acquisition unit 802 is configured to: each time a transaction shard is aggregated, determine, based on a prepare version carried in each log used to aggregate the transaction shard, a version corresponding to the transaction shard.

The heartbeat generating unit 806 is configured to send a global heartbeat value to each assembly queue at an interval of a predetermined time period, where the global heartbeat value is equal to the smallest value of versions carried in transaction shards sent to the assembly queues in the predetermined time period.

Accordingly, the transaction sequencing unit 805 is specifically configured to: separately obtain global heartbeat values from all the assembly queues; if a same global heartbeat value is separately obtained from all the assembly queues, update, by using the same global heartbeat value, a commit checkpoint corresponding to the sequence queue; and output transaction data in the sequence queue and whose commit version is less than or equal to the commit checkpoint.

In an implementation, a version carried in a transaction shard is one of prepare versions carried in logs used to aggregate the transaction shard.

In another implementation, a version carried in a transaction shard is a commit version of a transaction to which the transaction shard belongs, where the commit version is equal to the largest value of prepare versions carried in logs corresponding to the transaction.

The embodiments of this specification are described in a progressive method. For same or similar parts in the embodiments, refer to each other. Each embodiment focuses on a difference from other embodiments. Particularly, the apparatus embodiments are basically similar to the method embodiments, and therefore are described briefly. For related parts, references can be made to related descriptions in the method embodiments.

A person skilled in the art should be aware that in the above-mentioned one or more examples, the functions described in this specification can be implemented by hardware, software, firmware, or any combination thereof. When being implemented by software, these functions can be stored in a computer-readable medium or transmitted as one or more instructions or code on a computer-readable medium.

Some embodiments of this specification further provide a computer-readable storage medium, where the computer-readable storage medium stores a computer program. When the program is executed by a processor, the steps of the method described in any one of the method embodiments are implemented.

An electronic device is provided, and includes one or more processors and a memory associated with the one or more processors, where the memory is configured to store program instructions, and when the program instructions are read and executed by the one or more processors, the steps of the method in any one of the method embodiments are performed.

Some embodiments of this specification further provide a computer program product, including a computer program. When the computer program is executed by a processor, the steps of the method in any one of the method embodiments are implemented.

The memory can be implemented in a form of a read-only memory (ROM), a random access memory (RAM), a static storage device, a dynamic storage device, etc.

It can be learned from the previous descriptions of the implementations that, a person skilled in the art can clearly understand that the embodiments of this specification can be implemented by using software and a necessary general hardware platform. Based on such an understanding, the technical solutions in the embodiments of this specification essentially or the part contributing to the existing technology can be implemented in a form of a computer program product. The computer program product can be stored in a storage medium, such as a ROM/RAM, a magnetic disk, or an optical disc, and includes several instructions for instructing a computer device (which can be a personal computer, a server, a network device, etc.) to perform the methods described in the embodiments or in some parts of the embodiments of this specification.

In the above-mentioned specific implementations, the objectives, technical solutions, and beneficial effects of this specification are further described in detail. It should be understood that the above-mentioned descriptions are merely specific implementations of this specification, but are not intended to limit the protection scope of this specification. Any modification, equivalent replacement, improvement, etc. made based on the technical solutions of this specification shall fall within the protection scope of this specification.

1. A transaction log processing method, wherein a transaction is a database operation sequence for accessing and/or operating data, all logs corresponding to one transaction are written into at least two log streams in a distributed database, and the method comprises:
obtaining at least two log streams from the distributed database, wherein each log stream carries a transaction identifier; and
determining, based on the transaction identifier carried in each log stream, whether all log streams into which all logs corresponding to one transaction are written have been obtained; and upon determining that all log streams into which all logs corresponding to one transaction are written have been obtained, performing data assembly by using all the log streams to obtain transaction data corresponding to the transaction.

2. The method according to claim 1, wherein the method further comprises: for each obtained log stream, performing the following operations:
obtaining logs corresponding to a same transaction from the current log stream; and
aggregating the obtained logs into a transaction shard corresponding to the transaction, wherein the transaction shard carries an identifier of the current log stream and a transaction identifier of the transaction;
accordingly, determining whether all log streams into which all logs corresponding to one transaction are written have been obtained comprises:
determining, based on an identifier of a log stream and a transaction identifier that are obtained from each transaction shard, whether all log streams into which all logs corresponding to one transaction are written have been obtained; and
accordingly, the performing data assembly by using all the log streams comprises:
assembling all transaction shards that carry a same transaction identifier.

3. The method according to claim 2, wherein the method further comprises: each transaction identifier corresponds to a log stream list, and the log stream list comprises identifiers of all log streams into which all logs corresponding to a transaction with the transaction identifier are written; and
accordingly, determining, based on an identifier of the log stream and the transaction identifier that are obtained from each transaction shard, whether all log streams into which all logs corresponding to one transaction are written have been obtained comprises:
for each transaction shard, performing the following operations: obtaining the identifier of the log stream and the transaction identifier from the current transaction shard, and marking, in a log stream list corresponding to the obtained transaction identifier, the obtained identifier of the log stream as arrival; and
for each log stream list, upon determining that identifiers of all log streams in the current log stream list are marked as arrival, determining that all log streams into which all logs corresponding to one transaction are written have been obtained, wherein a transaction identifier of the transaction corresponds to the current log stream list.

4. The method according to claim 2, wherein each time a transaction shard is aggregated, the method further comprises: sending the aggregated transaction shard to one of more than one assembly queue; and
before determining, based on the identifier of the log stream and the transaction identifier that are obtained from each transaction shard, whether all log streams into which all logs corresponding to one transaction are written have been obtained, the method further comprises: separately obtaining each transaction shard from the more than one assembly queue by using at least one thread.

5. The method according to claim 2, wherein each log that is written into a log stream carries a prepare version; and
after the transaction data corresponding to the transaction is obtained, the method further comprises: determining a sequence of transactions based on the prepare version carried in each log, and successively outputting transaction data of each transaction based on the sequence.

6. The method according to claim 5, wherein assembling all transaction shards that carry the same transaction identifier further comprises:
each time transaction data of a transaction is assembled, determining a commit version of the transaction data by using a prepare version carried in each log corresponding to the transaction, carrying the determined commit version in the transaction data, and then sending the transaction data to a sequence queue; and
successively outputting transaction data of each transaction based on the sequence comprises:
outputting the transaction data of each transaction by using a commit version in each piece of transaction data and the sequence queue, wherein an output sequence is consistent with the sequence of the transactions.

7. The method according to claim 6, wherein the method further comprises:
each time a transaction shard is aggregated, determining, based on a prepare version carried in each log used to aggregate the transaction shard, a version corresponding to the transaction shard;
carrying the version in the transaction shard, and sending the transaction shard to one of the more than one assembly queue; and
sending a global heartbeat value to each assembly queue at an interval of a predetermined time period, wherein the global heartbeat value is equal to the smallest value of versions carried in transaction shards sent to the assembly queues in the predetermined time period; and
accordingly, outputting the transaction data of each transaction by using a commit version in each piece of transaction data and the sequence queue comprises:
separately obtaining global heartbeat values from all the assembly queues; and
upon determining that a same global heartbeat value is separately obtained from all the assembly queues, updating, by using the same global heartbeat value, a commit checkpoint corresponding to the sequence queue; and outputting transaction data in the sequence queue and whose commit version is less than or equal to the commit checkpoint.

8. The method according to claim 7, wherein a version carried in a transaction shard is:
one of prepare versions carried in logs used to aggregate the transaction shard; or
a commit version of a transaction to which the transaction shard belongs, wherein the commit version is equal to the largest value of prepare versions carried in logs corresponding to the transaction.

9. (canceled)

10. A computing device, comprising a memory and a processor, wherein the memory stores executable code, and when the processor executes the executable code, the computing device is caused to implement a transaction log processing method, wherein a transaction is a database operation sequence for accessing and/or operating data, all logs corresponding to one transaction are written into at least two log streams in a distributed database, and the method comprises:
obtaining at least two log streams from the distributed database, wherein each log stream carries a transaction identifier; and
determining, based on the transaction identifier carried in each log stream, whether all log streams into which all logs corresponding to one transaction are written have been obtained;
and if yes, performing data assembly by using all the log streams to obtain transaction data corresponding to the transaction.

11. The computing device according to claim 10, wherein the method further comprises: for each obtained log stream, performing the following operations:
obtaining logs corresponding to a same transaction from the current log stream; and
aggregating the obtained logs into a transaction shard corresponding to the transaction, wherein the transaction shard carries an identifier of the current log stream and a transaction identifier of the transaction;
accordingly, determining whether all log streams into which all logs corresponding to one transaction are written have been obtained comprises:
determining, based on an identifier of a log stream and a transaction identifier that are obtained from each transaction shard, whether all log streams into which all logs corresponding to one transaction are written have been obtained; and
accordingly, the performing data assembly by using all the log streams comprises: assembling all transaction shards that carry a same transaction identifier.

12. The computing device according to claim 11, wherein the method further comprises: each transaction identifier corresponds to a log stream list, and the log stream list comprises identifiers of all log streams into which all logs corresponding to a transaction with the transaction identifier are written; and
accordingly, determining, based on an identifier of the log stream and the transaction identifier that are obtained from each transaction shard, whether all log streams into which all logs corresponding to one transaction are written have been obtained comprises:
for each transaction shard, performing the following operations: obtaining the identifier of the log stream and the transaction identifier from the current transaction shard, and marking, in a log stream list corresponding to the obtained transaction identifier, the obtained identifier of the log stream as arrival; and
for each log stream list, upon determining that identifiers of all log streams in the current log stream list are marked as arrival, determining that all log streams into which all logs corresponding to one transaction are written have been obtained, wherein a transaction identifier of the transaction corresponds to the current log stream list.

13. The computing device according to claim 11, wherein each time a transaction shard is aggregated, the method further comprises: sending the aggregated transaction shard to one of more than one assembly queue; and
before determining, based on the identifier of the log stream and the transaction identifier that are obtained from each transaction shard, whether all log streams into which all logs corresponding to one transaction are written have been obtained, the method further comprises: separately obtaining each transaction shard from the more than one assembly queue by using at least one thread.

14. The computing device according to claim 11, wherein each log that is written into a log stream carries a prepare version; and
after the transaction data corresponding to the transaction is obtained, the method further comprises: determining a sequence of transactions based on the prepare version carried in each log, and successively outputting transaction data of each transaction based on the sequence.

15. The computing device according to claim 14, wherein assembling all transaction shards that carry the same transaction identifier further comprises:
each time transaction data of a transaction is assembled, determining a commit version of the transaction data by using a prepare version carried in each log corresponding to the transaction, carrying the determined commit version in the transaction data, and then sending the transaction data to a sequence queue; and
successively outputting transaction data of each transaction based on the sequence comprises:
outputting the transaction data of each transaction by using a commit version in each piece of transaction data and the sequence queue, wherein an output sequence is consistent with the sequence of the transactions.

16. The computing device according to claim 15, wherein the method further comprises:
each time a transaction shard is aggregated, determining, based on a prepare version carried in each log used to aggregate the transaction shard, a version corresponding to the transaction shard;
carrying the version in the transaction shard, and sending the transaction shard to one of the more than one assembly queue; and
sending a global heartbeat value to each assembly queue at an interval of a predetermined time period, wherein the global heartbeat value is equal to the smallest value of versions carried in transaction shards sent to the assembly queues in the predetermined time period; and
accordingly, outputting the transaction data of each transaction by using a commit version in each piece of transaction data and the sequence queue comprises:
separately obtaining global heartbeat values from all the assembly queues; and
upon determining that a same global heartbeat value is separately obtained from all the assembly queues, updating, by using the same global heartbeat value, a commit checkpoint corresponding to the sequence queue; and outputting transaction data in the sequence queue and whose commit version is less than or equal to the commit checkpoint.

17. The computing device according to claim 16, wherein a version carried in a transaction shard is:
one of prepare versions carried in logs used to aggregate the transaction shard; or
a commit version of a transaction to which the transaction shard belongs, wherein the commit version is equal to the largest value of prepare versions carried in logs corresponding to the transaction.

18. A non-transitory computer-readable storage medium, wherein the computer-readable storage medium stores computer instructions, and when the instructions are executed by a processor, the processor is caused to implement a transaction log processing method, wherein a transaction is a database operation sequence for accessing and/or operating data, all logs corresponding to one transaction are written into at least two log streams in a distributed database, and the method comprises:
obtaining at least two log streams from the distributed database, wherein each log stream carries a transaction identifier; and
determining, based on the transaction identifier carried in each log stream, whether all log streams into which all logs corresponding to one transaction are written have been obtained; and if yes, performing data assembly by using all the log streams to obtain transaction data corresponding to the transaction.

19. The non-transitory computer-readable storage medium according to claim 18, wherein the method further comprises: for each obtained log stream, performing the following operations:
obtaining logs corresponding to a same transaction from the current log stream; and
aggregating the obtained logs into a transaction shard corresponding to the transaction, wherein the transaction shard carries an identifier of the current log stream and a transaction identifier of the transaction;
accordingly, determining whether all log streams into which all logs corresponding to one transaction are written have been obtained comprises:
determining, based on an identifier of a log stream and a transaction identifier that are obtained from each transaction shard, whether all log streams into which all logs corresponding to one transaction are written have been obtained; and
accordingly, the performing data assembly by using all the log streams comprises: assembling all transaction shards that carry a same transaction identifier.

20. The non-transitory computer-readable storage medium according to claim 19, wherein the method further comprises: each transaction identifier corresponds to a log stream list, and the log stream list comprises identifiers of all log streams into which all logs corresponding to a transaction with the transaction identifier are written; and
accordingly, determining, based on an identifier of the log stream and the transaction identifier that are obtained from each transaction shard, whether all log streams into which all logs corresponding to one transaction are written have been obtained comprises:
for each transaction shard, performing the following operations: obtaining the identifier of the log stream and the transaction identifier from the current transaction shard, and marking, in a log stream list corresponding to the obtained transaction identifier, the obtained identifier of the log stream as arrival; and
for each log stream list, upon determining that identifiers of all log streams in the current log stream list are marked as arrival, determining that all log streams into which all logs corresponding to one transaction are written have been obtained, wherein a transaction identifier of the transaction corresponds to the current log stream list.

21. The non-transitory computer-readable storage medium according to claim 19, wherein each time a transaction shard is aggregated, the method further comprises: sending the aggregated transaction shard to one of more than one assembly queue; and
before determining, based on the identifier of the log stream and the transaction identifier that are obtained from each transaction shard, whether all log streams into which all logs corresponding to one transaction are written have been obtained, the method further comprises: separately obtaining each transaction shard from the more than one assembly queue by using at least one thread.
